(19) United States
(12) Patent Application Publication
(10) Pub. No.: US 2015/0054241 A1
(43) Pub. Date: Feb. 26, 2015

(54) WHEELBARROW WITH ROTATABLE HAND GRIPS

(71) Applicant: Norbert T. Wierszewski, Dearborn, MI (US)

(72) Inventor: Norbert T. Wierszewski, Dearborn, MI (US)

(21) Appl. No.: 13/971,461

(22) Filed: Aug. 20, 2013

(51) Int. Cl. B62B 1/18

(52) U.S. Cl. CPC B62B 1/18
USPC 280/47.31

(57) ABSTRACT

In order to allow a wheeled vehicle such as a wheelbarrow to be rolled about a supporting surface and also to be elevated above the front wheel, a pair of handles is provided adapted to be secured to the ends of the handles of the wheelbarrow with the handles comprising rings disposed in a vertical plane extending through the handles and supporting inner rotatable rings or races bisected by handle members which are supported on the inner ring. In this manner the wheelbarrow may be propelled by supporting the handle members as extensions of the wheelbarrow handles and the load may be dumped by elevating the wheelbarrow handles so that the rotatable handles extend downwardly at a comfortable angle.

### FIELD OF THE INVENTION

This invention relates to handles for wheelbarrows and like load-carrying devices having a pair of shafts terminating in handles and more particularly to improved handles which may be positioned at different angles to the wheelbarrow handles while pushing the load or dumping the load.

### BACKGROUND OF THE INVENTION

A variety of hand propelled load-carrying devices, such as wheelbarrows and the like, include a pair of rearwardly projecting handles disposed on the opposite sides of the load-bearing body. These handles may be conveniently grasped by a user's opposite hands to lift and propel the wheelbarrow. However, when the load carried in the wheelbarrow is to be dumped by tilting the handles upwardly about the front wheels, the wheelbarrow handles project at an angle that is very difficult for the user to grasp.

This problem has been recognized over the years and has resulted in a variety of solutions, all involving extensions for the wheelbarrow handles that may be rotated, at an angle to the handles, when the wheelbarrow is tipped. This allows a user to maintain a constant grip on the handle extensions while the wheelbarrow is being propelled on the level or tilted to dump the load.

Considering the designs shown in previous U.S. patents, U.S. Pat. No. 3,173,705 discloses attachments for the end of the wheelbarrow handles comprising circular segments pivotably attached to the undersides of the handle so as to allow the pivotable sections to rotate in the vertical plane. However, the curved handle members may be convenient for lifting the wheelbarrow handles but it is difficult to push the wheelbarrow using these handles because they tend to flip about the pivotable connection.

U.S. Pat. No. 4,951,956 proposes circular handle members 25 with bisecting handles 36 with the rings pivotably supported about a horizontal axis transverse to the wheelbarrow handles. This support mechanism for the handle projects laterally outward relative to the handles and the sides of the load-carrying structure of the wheelbarrow and reduces the ability of the wheelbarrow to be pushed through narrow openings. It also places the entire lifting force on the pivot axis.

U.S. Pat. No. 6,125,512 discloses an elongated extension for wheelbarrow handles which is pivotably supported for motion in a vertical plane encompassing the handles. In order to allow these handles to push the load without pivoting, a lock member retains them in a position as a straight extension of the handle members and the lock member may be released when it is necessary to dump the load. In practice it is difficult to release the lock member for dumping while maintaining the grip on the handle member.

The present invention is accordingly directed toward a rotatable handle which may be formed integrally at the projecting rear ends of handles for wheelbarrows and the like or may be provided as an accessory that can be fixed to the ends of conventional wheelbarrow handles that overcomes these disadvantages of the prior art.

### SUMMARY OF THE INVENTION

The rotatable handle extensions of the present invention are either integrally formed or adapted to be attached to the rearward projecting ends of the two handles. They comprise outer rings fixed on the wheelbarrow handles and disposed in a vertical plane that passes through the wheelbarrow handles. These outer rings support ring shaped inner races which are rotatable within the fixed outer races. The inner races are bisected by straight handle members which are thus supported for rotation in a vertical plane passing through the handles and are fully rotatable within that plane. These handles may be naturally grasped from their top sides and easily used to propel the wheelbarrow with the handles generally extending as extensions of the wheelbarrow handles or to tip the wheelbarrow by forcing the handles upwardly while retaining the same natural grip on the handles.

The full contact area between the rotatable inner rings and the fixed outer rings allows for an even application of forces exerted on the handles to be transferred to the outer rings and thus the wheelbarrow handles. The handle extensions do not have a lateral projection outwardly from the handle sides so as to increase the necessary width of passageways through which the wheelbarrow is moved.

The provision of a full circular bearing surface between the stationary outer ring and the rotatable inner ring equally distributes the loading between the hand grip and the wheelbarrow resulting in a substantially stronger structure than prior art arrangements such as that of U.S. Pat. No. 4,951,956 wherein the entire load is imposed on two pins 58.

### BRIEF DESCRIPTION OF THE DRAWINGS

Other objectives, advantages, and applications of the present invention will be made apparent by the following detailed description of preferred embodiments of the invention. The description makes reference to the following drawings in which:

FIG. 1 is a perspective view of a wheelbarrow having the unique handle extension members of the present invention secured to the rearward projecting ends of the wheelbarrow handles;

FIG. 2 is a side view of the unique handle of the present invention;

FIG. 3 is an end view of the handle of the present invention;

FIG. 4 is a cross-sectional view through the handle taken along lines 4-4 of FIG. 3;

FIG. 5 is an exploded view of the handle extension and the end section of the wheelbarrow handle illustrating the method of attachment; and

FIG. 6A is an illustration of a wheelbarrow with the handle extensions of the present invention being pushed on a level surface;

FIG. 6B is an illustration_of the wheelbarrow being tilted upwardly for dumping; and

FIG. 6C is an illustration of the wheelbarrow in a totally dumping position, in each case illustrating the position of one of the hands of the operator in the extension.

### DETAILED DESCRIPTION OF A PREFERRED EMBODIMENT OF THE INVENTION

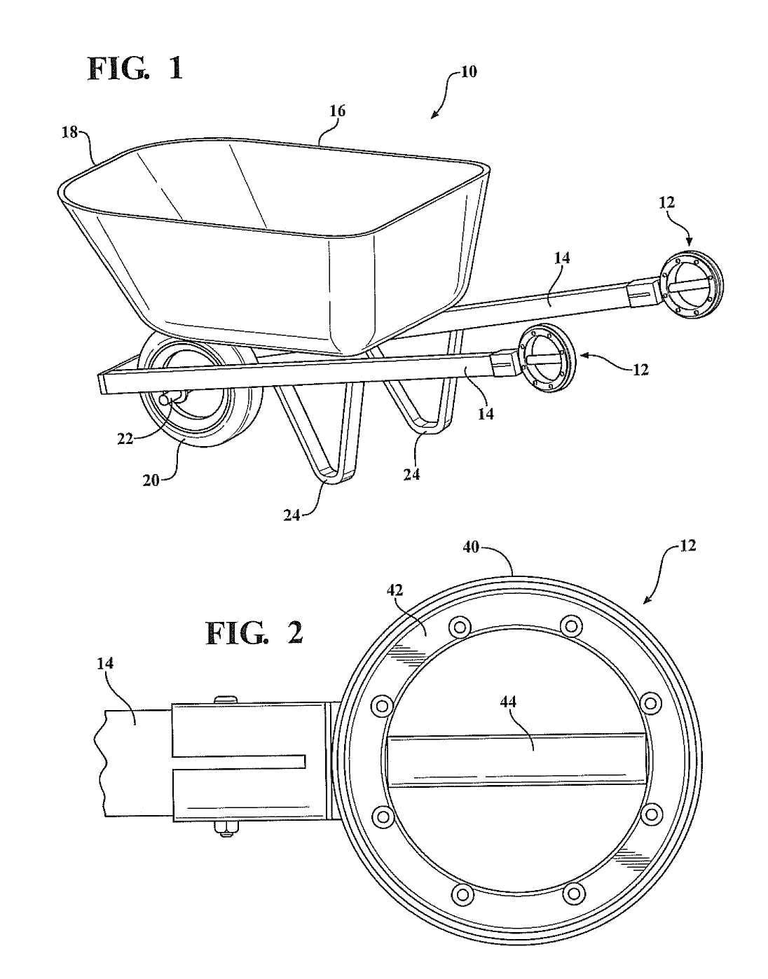

Referring to the drawings, FIG. 1 is a view of a wheelbarrow, generally indicated at 10, which is conventional except for the rotating handle extension assemblies generally indicated at 12 supported on the projecting ends of each of the wheelbarrow handles 14. The wheelbarrow generally comprises an open top load container 16 having a rounded forward edge 18 which acts as a spout when the wheelbarrow is tipped to unload. The wheelbarrow has a forward wheel 20 supported on an axle 22 which extends laterally between the forward ends of the two handles 14. A pair of support stands 24 project downwardly from the handles 14 midway along their length.

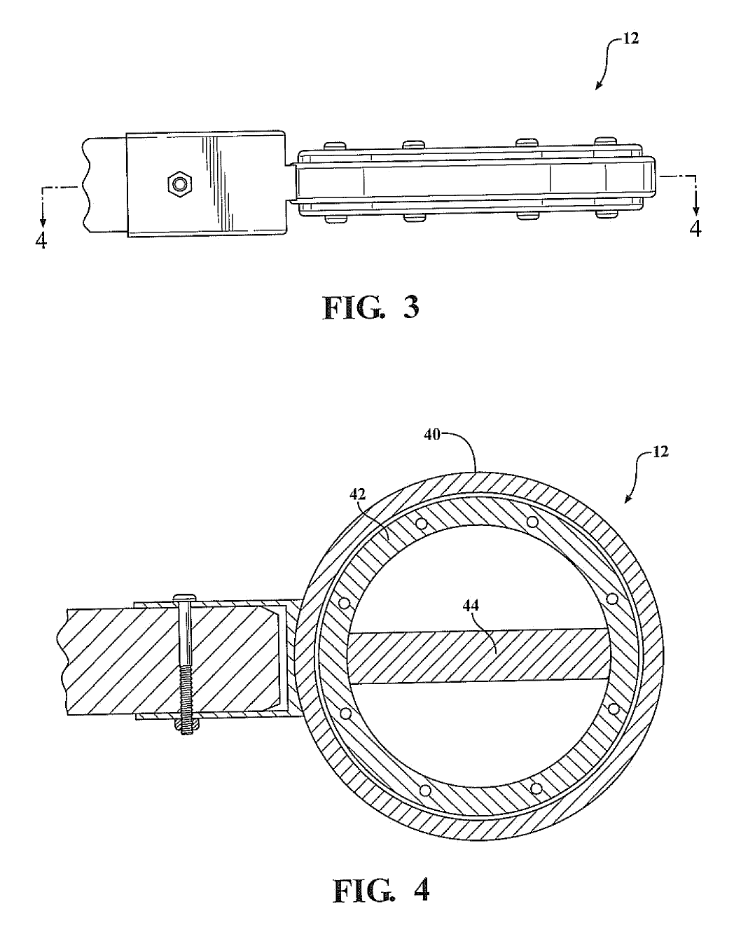

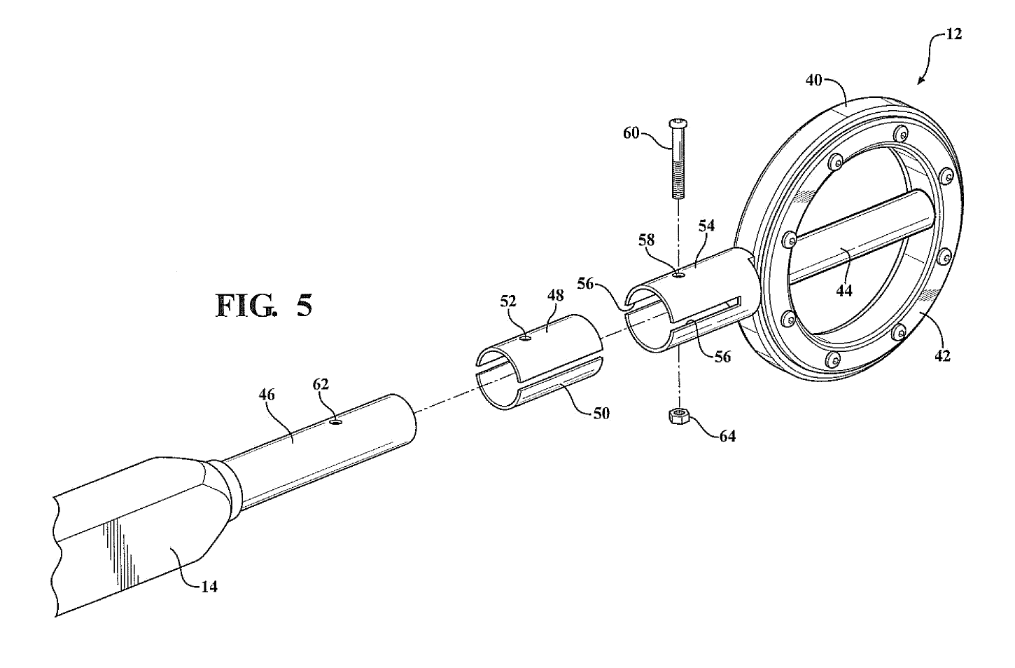

The rotatable handle extension members 12 of the present invention are detailed in FIGS. 2-5. Broadly they comprise an outer ring 40 which is fixed relative to its respective wheelbarrow handle 14 so that the ring 40 is disposed in a generally vertical plane, when the wheelbarrow is in a normal position, the same plane as the wheel 20 and rotatably supports an inner ring 42. The inner ring is bisected by a handle 44. As illustrated in FIG. 5, each handle member, which is generally rectangular, terminates in a cylindrical extension 46. A pair of semicylindrical adaptor plates 48 and 50, having an inner diameter corresponding to the outer diameter of the cylindrical section 46, extends over opposed sides of the section 46. Each of the adaptor plates 48 and 50 has a hole 52.

A round tube section 54 having a pair of slits 56 on diametrically opposed sides, extending partially through the length of the section 54, is formed integrally with the outer ring 40 of the rotatable handle. The section 54 has a pair of holes 58 formed through its opposed sides. The adaptor sleeves 48 and 50 are wrapped around the cylindrical section 46 of the wheelbarrow handle and then a bolt 60 is passed through the holes 58 on the tube 54 and the holes 52 on the adaptor plates 58 and 50 and through the corresponding hole 62 on the cylindrical section of the handle 46. The bolt 60 is secured on the opposite side by a nut 64.

In an alternative embodiment, ball bushings or the like may be supported between the fixed outer ring 40 and the rotatable section 42 to reduce friction.

Also in an alternative embodiment the end of the wheelbarrow handles 14 may not terminate in a cylindrical section but rather in a rectangular section and the parts 48, 50 and 54 could be formed to accommodate that rectangular section.

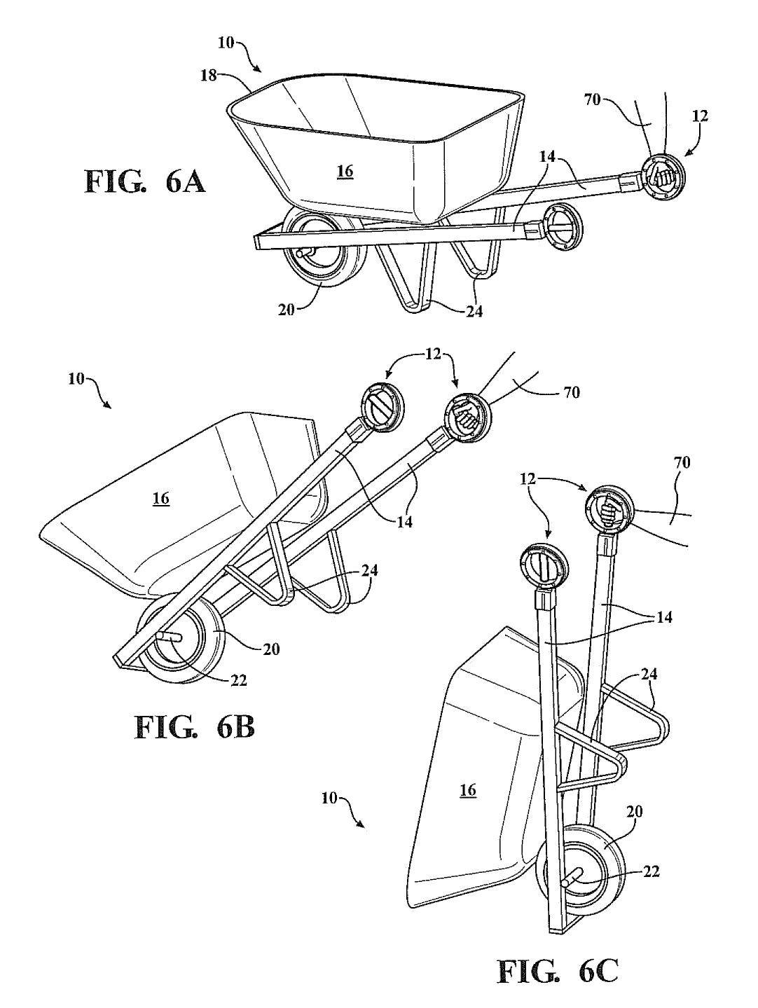

As illustrated in FIGS. 6A, 6B and 6C, a user may grasp the two rotatable handle sections 44. An arm 70 is illustrated as terminating in a hand 72 which engages the handle members 44. The user's hand will be positioned with the element 44 as an extension of the handle members 14 to push the wheelbarrow over a generally level surface as shown in FIG. 6A. When the wheelbarrow is to be tilted as shown in FIG. 6B, the user can maintain the same grasp of the handle member 44 and allow the wheelbarrow 10 to pivot. Finally, as shown in FIG. 6C, the same grasp may be maintained as the wheelbarrow is tipped to a full vertical position.

By distributing the forces imposed between the wheelbarrow handle member 14 and the rotating handle member 44 over the full bearing surface between the fixed outer member 40 and the rotatable inner ring 44, the handle members of the present invention are greatly strengthened relative to the prior art devices which place the entire load on a pivot point. Additionally, the rotatable handle does not in any way extend the width of the grip on the wheelbarrow handles so as to limit the wheelbarrow passage through narrow apertures.

In other embodiments of the invention the rotatable handle members could be formed integrally with the wheelbarrow by the manufacturer, not requiring the attachment apparatus illustrated in FIG. 5.

Having thus described my invention, I claim:

1. Handle extension members for a manually propelled wheeled load carrier having a pair of elongated handles, comprising:
fixed outer rings having interior diameters elongated secured to each handle member, the outer rings being disposed in a vertical plane when the load carrier is in a normal position; and
inner rings having their outer diameters bearing on the interior diameters of the outer rings, so as to be rotatable therein; and
elongated handle members bisecting the interior diameters of each inner ring.

2. The handle extension members of claim 1, wherein the outer rings are secured to the handle members by being integrally connected to the handle members.

3. The handle extension members of claim 1, wherein the outer rings are secured to the handle members by removable connectors.

4. The handle extension members of claim 1, including bearing members disposed between the inner diameters of the outer rings and outer diameters of the inner rings.
